(19) United States
(12) Patent Application Publication
(10) Pub. No.: US 2018/0083506 A1
(43) Pub. Date: Mar. 22, 2018

(54) Electric Motor

(71) Applicant: Johnson Electric S.A., Murten (CH)

(72) Inventor: Yvan Bourqui, Cominboeuf (CH)

(21) Appl. No.: 15/706,162

(22) Filed: Sep. 15, 2017

(30) Foreign Application Priority Data
Sep. 16, 2016 (GB) 1615848.7

(51) Int. Cl. H02K 3/32; H02K 7/116; H02K 5/04; H02K 11/00; H02K 15/14

(52) U.S. Cl. CPC H02K 3/325; H02K 7/116; H02K 15/14; H02K 11/0094; H02K 5/04

(57) ABSTRACT

An electric motor comprising: a bobbin having a rotor receiving portion and a plurality of winding supporting portions at or adjacent to the rotor receiving portion; a rotor receivably mountable at the rotor receiving portion; a plurality of core lamination units engagable with the winding supporting portions; and a stator winding mountable about an outer surface of one of the stator engagement members. An electrical connector is also provided which has a connector body and at least one electrically-conductive element associated therewith, the connector body being integrally formed with the stator engagement member of the bobbin.

### CROSS REFERENCE TO RELATED APPLICATIONS

This non-provisional patent application claims priority under 35 U.S.C. § 119(a) from Patent Application No. 1615848.7 filed in United Kingdom on Sep. 16, 2016.

### FIELD OF THE INVENTION

The present invention relates to an electric motor, particularly but not necessarily exclusively to a stepper motor formed as a star motor. The invention further relates to a bobbin for such an electric motor, and also to a method of assembling the electric motor

### BACKGROUND OF THE INVENTION

Stepper motors are electric motors which rotate in a stepwise fashion, providing very precise control over the degree of rotation of the output of the motor. There are two main ways in which such a motor is traditionally formed.

A cylindrical stepper motor has a stator and a rotor which are coaxially aligned, the stator, including stator coil windings, surrounding the rotor, which can rotate relative to the stator and from which an output can be taken. Such a motor is relatively straightforward to manufacture, but is also quite voluminous.

A star motor has a central rotor and a plurality of stator windings equi-angularly positioned around the rotor. A unitary core lamination unit is then typically received around the stator windings. Such an arrangement generally has a relatively large depth, but can be formed so as to have relatively small footprint compared to the cylindrical equivalent. This may be preferable in certain applications.

In both stepper motor arrangements, the stator windings must be connected individually to an electrical connector in order to be connectable to other electronic components and/or power supplies once the motor has been inserted into its motor housing. This electrical connector is provided as a separate component, typically formed from a plastics material having at least one conductor therethrough. The electrical connector must be wired or soldered directly to the motor so as to be electrical communication with the stator windings in order to power and control the motor. This process is both laborious and prone to failure if the connection is not correctly made.

Furthermore, in order to house the electric motor in its housing it is necessary to first insert the motor components first in order to correctly seat the rotor and stator in position, before then attaching the electrical connector in situ. Often this is the only way in which the physical insertion of the motor into the motor housing can be achieved, given that the size of the finished motor is often one of the most critical factors in its potential utility.

### SUMMARY OF THE INVENTION

The present invention seeks to provide a solution to these problems by providing an improved electrical connector configuration and method of assembling an electric motor.

According to a first aspect of the invention, there is provided an electric motor comprising: a bobbin having a rotor receiving portion and a winding supporting portion at or adjacent to the rotor receiving portion; a rotor receivably mountable at the rotor receiving portion; a core lamination unit engagable with the winding supporting portion; a stator winding mountable about an outer surface of the winding supporting portion; and an electrical connector having a connector body and at least one electrically conductive element associated therewith, the connector body being integrally formed with the winding supporting portion of the bobbin.

By providing an electrical connector which is integrally formed with the bobbin of an electric motor, it becomes possible to avert the need to electrically connect the stator windings to an external power source for operation of the motor. This advantageously allows for the electrical connections of the motor to be assembled prior to installation into the motor housing, which can dramatically simplify the assembly of the motor. Furthermore, the total number of components which are required to assemble the motor is reduced, as well as the number of connections required, which in turn reduces the manufacturing cost of the motor and reduces the likelihood of failure of the motor due to a connection interruption.

Preferably, the connector body of the electrical connector may be spaced apart from the rotor receiving portion along an axis of rotation of the rotor.

Axial spacing of the electrical connector from the rotor not only allows for the core lamination unit associated with the respective winding supporting portion to be readily engaged, but also may allow the connector body to act as a support for the whole motor inside its motor housing, which may reduce the requirement for separate frameworks to support the rotor and stator.

Optionally, the winding supporting portion may comprise a member body which extends from the rotor receiving portion and an end cap at a distal end of the member body, the stator winding being mountable about the member body, in which case, the member body may include a receiving aperture therethrough within which at least part of the core lamination unit is receivable.

The engagement of the stator with the bobbin as multiple core lamination units is an improvement over existing star motors which have a unitary stator. This allows the winding of the stator windings about the bobbin prior to the engagement of the stator, which in turn allows for the connection of the stator windings to the electrical connector prior to installation of the electric motor into its housing.

The electrical connector may be positioned at a distalmost end of the winding supporting portion relative to the rotor receiving portion. Furthermore, in one embodiment, the electrical connector may project beyond the core lamination unit when engaged with the winding supporting portion. Optionally, the at least one electrically-conductive element may extend from the electrical connector in parallel with a longitudinal direction of the winding supporting portion.

The positioning of the electrical connector at a distalmost end of the winding supporting portion, which may give the profile of the electric motor the appearance of that of a crucifix, enables the electrical connector to be relatively distant from the rotor, which may simplify the engagement of the electrical connector with a portion of the motor housing through which it can couple to onward electrical components.

Preferably, the bobbin may include at least one further winding supporting portion, at least one further core lamination unit and at least one further stator winding, in which case the winding supporting portion and the at least one further winding supporting portion may be angularly equi-positioned about the rotor receiving portion.

The electric motor is preferably formed as a star motor, having a plurality of further core lamination units to which no electrical connector is attached. This may allow the finally assembled electric motor to have a relatively small footprint, making it more useful for particular applications, particularly in the context of heating, ventilation and air conditioning systems, for example, in motor vehicles.

According to a second aspect of the invention, there is provided an actuator comprising an electric motor in accordance with the first aspect of the invention and a motor housing which supports at least the bobbin, which may also include at least one output gear mountable within the motor housing. Furthermore, the bobbin may be directly mounted to the motor housing, and additionally or alternatively, the motor housing may be a two-part enclosure.

The electric motor is designed to be easily installed into its motor housing, which may be relatively small, thereby forming a compact actuator. The preforming of the electrical connector on the bobbin so that the electrical connections can be formed prior to installation into the motor housing eliminates the need to perform any connecting or soldering once the electric motor is received within the housing. This may in turn allow the motor housing to be formed so as to be more compact.

According to a third aspect of the invention, there is provided a bobbin for an electric motor, the bobbin having a rotor receiving portion, a winding supporting portion at or adjacent to the rotor receiving portion, and an electrical connector having a connector body and at least one electrically-conductive element associated therewith, the connector body being integrally formed with the winding supporting portion.

The provision of a specific bobbin having an electrical connector integrally formed therewith allows for the framework of the electric motor to be assembled and formed so as to be electrically functional even in advance of the engagement of the stators. The fewer components which must be attached to the bobbin before the electrical connections are made the better, since there is greater freedom to interact with the bobbin unobstructed in advance of the engagement of the stator.

According to a fourth aspect of the invention, there is provided a method of assembling an electric motor, the method comprising the steps of: a] providing a bobbin, preferably in accordance with the second aspect of the invention; b] winding a stator winding around an outer surface of the winding supporting portion; c] connecting the stator winding to the electrically-conductive element of the electrical connector to form an electrically-functional bobbin unit; and d] engaging a core lamination unit with the winding supporting portion and a rotor with the rotor receiving portion to form an electric motor.

The present methodology enables the assembly of an electric motor such that a fully electrically-functional unit is introduced directly into the motor housing ready for sealing, negating the need to provide separate connections once the motor components have been installed into the motor housing.

The invention will now be more particularly described, with reference to the accompanying drawings, in which:

### BRIEF DESCRIPTION OF THE DRAWINGS

FIG. 1 shows a perspective representation of a one embodiment of an electric motor in accordance with the first aspect of the invention;

FIG. 2 shows a perspective representation of the bobbin of the electric motor shown in FIG. 1; and

FIG. 3 shows an exploded perspective representation of one embodiment of an actuator in accordance with the second aspect of the invention.

The present invention will be further described below with reference to the accompanying drawings and the following embodiments.

### DETAILED DESCRIPTION OF THE PREFERRED EMBODIMENTS

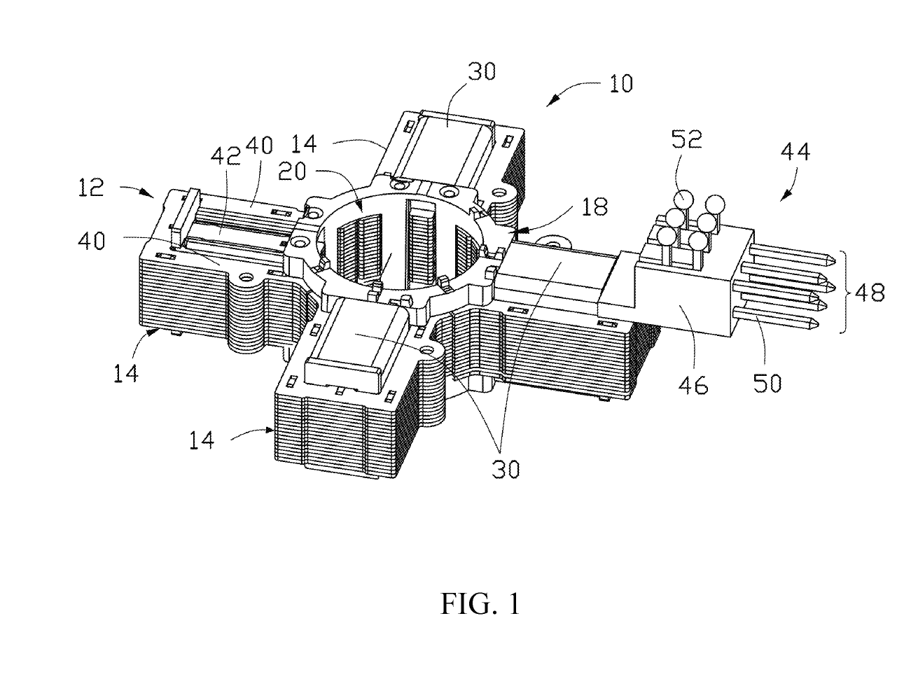

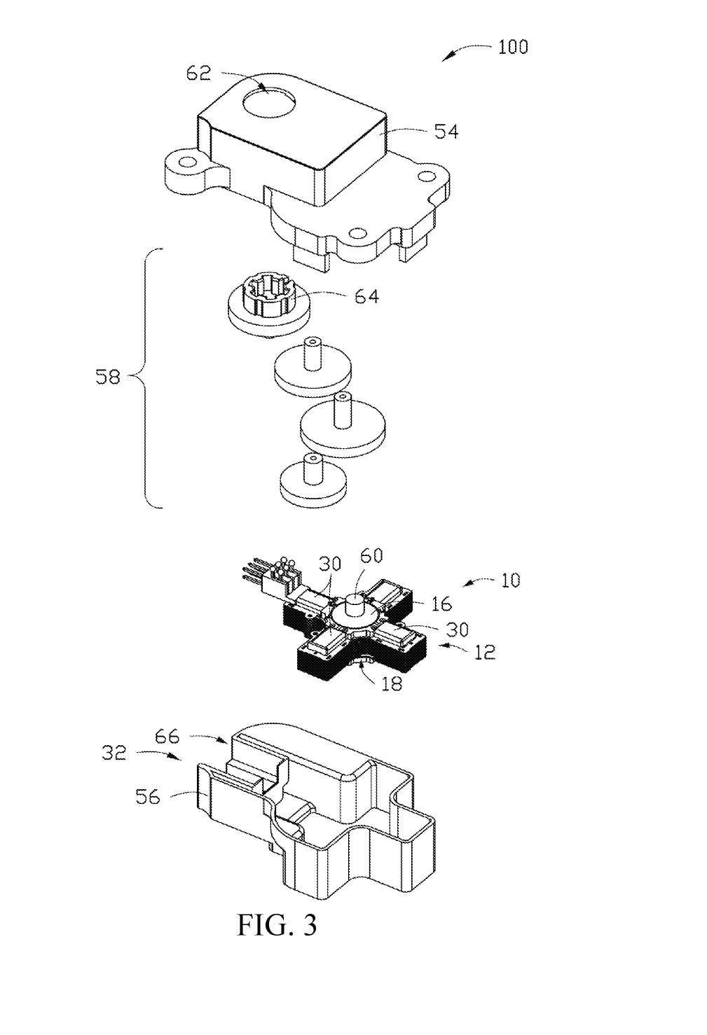

Referring firstly to FIG. 1, there is shown an electric motor, indicated globally at 10, and which is here formed as a star motor. The star motor includes a stator 12 and a rotor 16 rotatably mounted relative to the stator 12. The rotor 16 is omitted from FIG. 1 for clarity, but can be seen in FIG. 3. Whilst a star motor is used in the present embodiment, it will be apparent that the following invention could be utilised in a wide variety of electric motors, in particular for stepper motors, and may be particularly useful in the context of stepper actuators such as those used in heating, ventilation and air conditioning systems, for instance, those provided in motor vehicles.

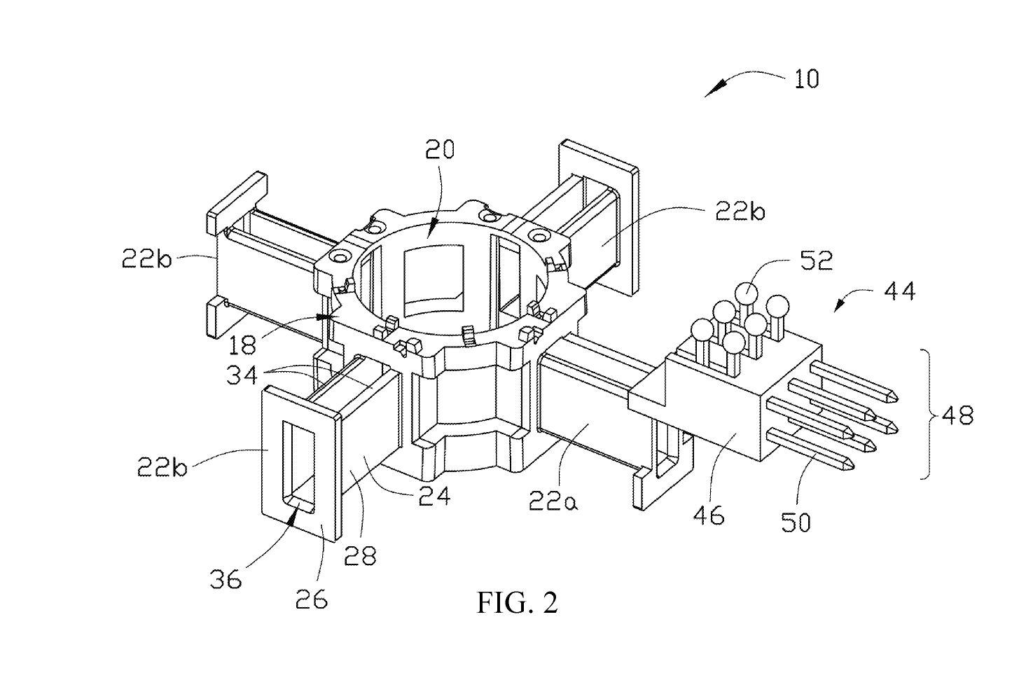

The stator 12 includes a bobbin 18, a plurality of windings 30 winding around the bobbin 18 and a core lamination unit 14 mounted to the bobbin 18. The bobbin 18, has a central rotor receiving portion 20 within which the rotor 16 is receivable and is able to rotate in use, and a plurality of winding supporting portions 22a, 22b which extend from the rotor receiving portion 20 and angularly equi-positioned about the rotor receiving portion 20. The bobbin 18 can be seen in detail in FIG. 2.

Each winding supporting portion 22a, 22b comprises a, preferably elongate, member body 24, which extends radially away from the rotor receiving portion 20 and terminates at an end cap 26. The end cap 26 extends proud of the member body 24 in a lateral direction, at least in part, so as to define a shoulder relative to an outer surface 28 of the member body 24. Stator windings 30 can be wound around the outer surface 28 of each winding supporting portion 22a, 22b, the end caps 26 preventing the stator windings 30 from sliding off the outer surface 28 of the winding supporting portions 22a, 22b. The precise shape of the end cap 26 may be determined by the need to engage the bobbin 18 with seating portions in a motor housing 32, as shown in FIG. 3, which shows an actuator 100 which incorporates the electric motor 10.

In the depicted embodiment, each of the member bodies 24 is formed from two parallel spaced apart body portions 34, which, in conjunction with a receiving aperture 36 in the associated end cap 26, defines a core lamination unit receptacle 38 in the member body 24.

The stator 12 is preferably formed from a plurality of discrete core lamination units 14, which are here formed so as to have three conjoined arms: two outer stator arms 40, an end of each outer stator arm 40 preferably being formed so as to match a curvature of the rotor receiving portion 20; and a central stator arm 42 which is receivable within the core lamination unit receptacle 38 to retain the core lamination unit 14 in position on its respective winding supporting portion 22a, 22b.

On one of the winding supporting portions 22a there is provided an electrical connector 44, which has a connector body 46 and at least one electrically-conductive element 48 extending therefrom. Here, the electrical connector 44 is formed as a male engagement connector, wherein the electrically-conductive elements 48 are formed as six projecting pins 50 which extend through the connector body 46 into corresponding connector terminals 52. Any appropriate form of electrical connector may be provided, of course, including female engagement connectors.

The electrical connector 44 is integrally formed with the bobbin 18, in this case extending from an end cap 26 of the winding supporting portion 22a to which it is attached. The electrical connector 44 is spaced apart from the rotor receiving portion 20 not only in the plane of the winding supporting portions 22a, 22b, but also in a direction parallel to the rotational axis of the rotor 16. This increases the height of the bobbin 18, and can allow the electrical connector 44 to act as a foot or support for the whole bobbin 18 inside the motor housing 32.

That the electrical connector 44 sits proud of the receiving aperture 36 allows the core lamination unit 14 engagable with the corresponding winding supporting portion 22a to be engaged therewith without difficulty. The electrical connector 44 may also project beyond the distalmost portion of the end cap 26 in a longitudinal direction of the winding supporting portion 22a, for example, with the pins 50 projecting outwardly from the end cap 26 to give the bobbin 18 an overall elongate cruciform profile, when viewed from above.

In a typical arrangement, the electric motor 10 is encased within a two-part motor housing 32, having an upper housing part 54 and a lower housing part 56, along with a plurality of gears 58 arranged in a gear train and which engage with an output gear 60 connected to the rotor 16 of the electric motor 10. The motor housing 32 has one opening 62 through which the output 64 of the gear train can project, and a further opening 66 via which the electrical connector can be accessed.

To assemble the electric motor 10, the user first must arrange the stator windings 30 around the winding supporting portions 22a, 22b, tightly winding the stator windings 30 about the respective outer surfaces 28 of the winding supporting portions 22a, 22b. The stator windings 30 can then be electrically connected to the connector terminals 52 as necessary, to enable connection to control circuitry or a power source, for instance, via the electrical connector 44 in due course. Once the stator windings 30 have been connected to the electrical connector 44, then a single electrically-functional bobbin unit is formed. This method of assembly therefore eliminates the need to solder or connect electrical components to the electric motor 10 after insertion into the motor housing 32, since all of the necessary functionality is built into the electrically-functional bobbin unit.

Once the electrically-functional bobbin unit is formed, the stator 12 can be assembled about the bobbin 18 by introducing core lamination units 14 to the winding supporting portions 14. In the present embodiment, this is achieved by introducing the central stator arm 44 into the stator receiving receptacle of the winding supporting portions 22a, 22b, with the outer stator arms 40 being receivable about the stator windings 30. To do so, the stator portions 14 are introduced to the winding supporting portions 22a, 22b in a longitudinal direction thereof. The rotor 16 can also then be inserted into the rotor receiving portion 20 so as to form the core elements of the electric motor 10.

The electric motor 10 can then be inserted into the motor housing 32, in which case the bobbin 18 may be directly seated onto a base of the motor housing 32. The plurality of gears 58 can then be inserted, and the motor housing 32 closed sealing the internal components in position. Assuming that the motor housing 32 is made to fit the bobbin 18, then the electrical connector 44 will be in position for onward connection to external components of the electric motor 10.

This arrangement advantageously ensures that the electrical functionality of the electric motor 10 can be pre-assembled before insertion into the motor housing 32, greatly simplifying the assembly of the electrically-conductive portions of the electric motor 10 when constructing a stepper actuator 100.

Whilst the above-described electric motor utilizes four winding supporting portions, it will be appreciated that, provided that there is rotational symmetry of the stator portions, that any suitable star arrangement of stator portions could be provided; arrangements with three stator portions are relatively common, and may result in a more compact electric motor.

It is therefore possible to provide an electric motor which has a bobbin having an electrical connector thereon which is integrally formed therewith. This arrangement significantly simplifies the assembly of an electric motor, particularly for a star motor arrangement, since all electrical connections can be formed prior to insertion of the bobbin into a motor housing. Furthermore, by forming the electrical connector with the bobbin, the electric motor can be provided as a simple and robust unit, reducing the likelihood of failure between otherwise interconnected components.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. An electric motor comprising:
a bobbin having a rotor receiving portion, and a first winding supporting portion, and at least one second winding supporting portion at or adjacent to the rotor receiving portion;
a rotor rotatably received in the rotor receiving portion;
a plurality of core lamination units respectively mounted to the first and second winding supporting portions;
a plurality of winding respectively mounted about the first and second winding supporting portions; and
an electrical connector having a connector body and at least one electrically-conductive element associated therewith, the connector body being integrally formed with the first winding supporting portion of the bobbin.

2. The electric motor as claimed in claim 1, wherein the connector body of the electrical connector is spaced apart from the rotor receiving portion along an axis of rotation of the rotor.

3. The electric motor as claimed in claim 1, wherein each of the first and second winding supporting portions comprises a member body which extends from the rotor receiving portion and an end cap at a distal end of the member body, the stator windings being correspondingly wound around the member bodies of the first and second winding supporting portions.

4. The electric motor as claimed in claim 3, wherein the member body comprises a receiving aperture therethrough within which at least part of the corresponding one of the core lamination unit is receivable.

5. The electric motor as claimed in claim 1, wherein the electrical connector is positioned at a distalmost end of the first winding supporting portion relative to the rotor receiving portion.

6. The electric motor as claimed in claim 1, wherein the electrical connector projects beyond the core lamination unit when engaged with the first winding supporting portion.

7. The electric motor as claimed in claim 1, wherein the at least one electrically-conductive element extends from the electrical connector in parallel with a longitudinal direction of the first winding supporting portion.

8. The electric motor as claimed in claim 1, wherein the first and second winding supporting portions are angularly equi-positioned about the rotor receiving portion.

9. An actuator comprising:
an electric motor as claimed in claim 1; and
a motor housing which supports at least the bobbin.

10. The actuator as claimed in claim 9, further comprising at least one output gear mountable within the motor housing.

11. The actuator as claimed in claim 9, wherein the bobbin is directly mounted to the motor housing.

12. The actuator as claimed in claim 9, wherein the motor housing is a two-part enclosure.

13. A bobbin for an electric motor, comprising:
a rotor receiving portion,
a plurality of winding supporting portions at or adjacent to the rotor receiving portion, and
an electrical connector having a connector body and at least one electrically conductive element associated therewith, the connector body being integrally formed with one of the winding supporting portions.

14. A method of assembling an electric motor, the method comprising the steps of:
a] providing a bobbin as claimed in claim 13;
b] winding a plurality of stator windings around an outer surface of the supporting portions, correspondingly;
c] connecting the stator winding to the electrically-conductive element of the electrical connector to form an electrically-functional bobbin; and
d] engaging a plurality of core lamination units with the supporting portions and a rotor with the rotor receiving portion to form an electric motor.
